(19) United States
(12) Patent Application Publication
(10) Pub. No.: US 2017/0078705 A1
(43) Pub. Date: Mar. 16, 2017

(54) VERIFICATION OF ERROR RECOVERY WITH LONG TERM REFERENCE PICTURES FOR VIDEO CODING

(71) Applicant: Microsoft Technology Licensing, LLC, Redmond, WA (US)

(72) Inventors: Mei-Hsuan Lu, Bellevue, WA (US); Yongjun Wu, Bellevue, WA (US); Ming-Chieh Lee, Bellevue, WA (US); Firoz Dalal, Sammamish, WA (US)

(73) Assignee: Microsoft Technology Licensing, LLC, Redmond, WA (US)

(21) Appl. No.: 14/850,412

(22) Filed: Sep. 10, 2015

(51) Int. Cl. H04N 19/895; H04N 19/65

(52) U.S. Cl. CPC H04N 19/895; H04N 19/65

(57) ABSTRACT

Techniques are described for verifying long-term reference (LTR) usage by a video encoder and/or a video decoder. For example, verifying that a video encoder and/or a video decoder is applying LTR correctly can done by encoding and decoding a video sequence in two different ways and comparing the results. In some implementations, verifying LTR usage is accomplished by decoding an encoded video sequence that has been encoded according to an LTR usage pattern, decoding a modified encoded video sequence that has been encoded according to the LTR usage pattern and modified according to a lossy channel model, and comparing decoded video content from both the encoded video sequence and the modified encoded video sequence. For example, the comparison can comprise determining whether both decoded video content match bit-exactly beginning from an LTR recovery point location.

### BACKGROUND

Engineers use compression (also called source coding or source encoding) to reduce the bit rate of digital video. Compression decreases the cost of storing and transmitting video information by converting the information into a lower bit rate form. Decompression (also called decoding) reconstructs a version of the original information from the compressed form. A “codec” is an encoder/decoder system.

Over the last two decades, various video codec standards have been adopted, including the ITU-T H.261, H.262 (MPEG-2 or ISO/IEC 13818-2), H.263 and H.264 (MPEG-4 AVC or ISO/IEC 14496-10) standards, the MPEG-1 (ISO/IEC 11172-2) and MPEG-4 Visual (ISO/IEC 14496-2) standards, the SMPTE 421M standard, and proprietary video coding formats such as VP8 and VP9. More recently, the HEVC standard (ITU-T H.265 or ISO/IEC 23008-2) has been approved. Extensions to the HEVC standard (e.g., for scalable video coding/decoding, for coding/decoding of video with higher fidelity in terms of sample bit depth or chroma sampling rate, or for multi-view coding/decoding) are currently under development. A video codec standard typically defines options for the syntax of an encoded video bitstream, detailing parameters in the bitstream when particular features are used in encoding and decoding. In many cases, a video codec standard also provides details about the decoding operations a decoder should perform to achieve conforming results in decoding. Aside from codec standards, various proprietary codec formats, such as VP8 and VP9, define other options for the syntax of an encoded video bitstream and corresponding decoding operations.

Various video codec standards can be used to encode and decode video data for communication over network channels, which can include wired or wireless networks, in which some data may be lost. Some video codec standards implement error recovery and concealment solutions to deal with loss of video data. One example of such error recovery and concealment solutions is the use of long term reference (LTR) pictures in H.264/AVC or HEVC/H.265. However, testing of such error recovery and concealment solutions can be difficult and time consuming

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Technologies are provided for verifying long-term reference (LTR) usage by a video encoder and/or a video decoder. For example, verifying that a video encoder and/or a video decoder is applying LTR correctly (e.g., in accordance with a particular video coding standard) can done by encoding and decoding a video sequence in two different ways and comparing the results. In some implementations, verifying LTR usage is accomplished by decoding an encoded video sequence that has been encoded according to an LTR usage pattern, decoding a modified encoded video sequence that has been encoded according to the LTR usage pattern and modified according to a lossy channel model, and comparing decoded video content from both the encoded video sequence and the modified encoded video sequence. For example, the comparison can comprise determining whether both decoded video content match beginning from an LTR recovery point location.

As described herein, a variety of other features and advantages can be incorporated into the technologies as desired.

### BRIEF DESCRIPTION OF THE DRAWINGS

FIG. 1 is an example diagram depicting a process for verifying LTR usage during encoding and/or decoding of video content.

FIG. 2 is an example diagram depicting modification of encoded video sequences used for verifying LTR usage.

FIGS. 3, 4, and 5 are flowcharts of example methods for verifying long term reference picture usage.

FIG. 6 is a diagram of an example computing system in which some described embodiments can be implemented.

### DETAILED DESCRIPTION

### Overview

As described herein, various techniques and solutions can be applied for verifying long-term reference (LTR) usage during encoding and/or decoding of video content. For example, verifying that a video encoder and/or a video decoder is applying LTR correctly (e.g., in accordance with a particular video coding standard) can done by encoding and decoding a video sequence in two different ways and comparing the results. In some implementations, verifying LTR usage is accomplished by decoding an encoded video sequence that has been encoded according to an LTR usage pattern, decoding a modified encoded video sequence that has been encoded according to the LTR usage pattern and modified according to a lossy channel model, and comparing decoded video content from both the encoded video sequence and the modified encoded video sequence. For example, the comparison can comprise determining whether both decoded video content match beginning from an LTR recovery point location, even when there are some frames that are lost in one sequence or both.

Video codec standards deal with lost video data using a number of error recovery and concealment solutions. One solution is to insert I-pictures at various locations which can then be used to recover from lost data or another type of error beginning with the next I-picture. Another solution is to use long-term reference (LTR) pictures in which a reference picture at some point in the past is maintained for use in an error recovery and concealment situation.

According to some video coding standards, LTR is used in error recovery and concealment between a server or sender (operating a video encoder) and a client or receiver (operating at video decoder). For example, a hand-shake message can be communicated between the server and client to acknowledge that an LTR picture has been properly received at the client which can then be used for error recovery. If an error happens (e.g., lost packers or data corruption), the client can inform the server. The server can then use the LTR picture (that has been acknowledged as properly received at the client) instead of the nearest temporal neighbor reference picture for encoding, as the nearest temporal neighbor reference picture might have been lost or corrupted. The client can then receive the bitstream from the server from the error recovery point that has been encoded using the acknowledged LTR picture.

Testing of error recovery and concealment solutions can be a manual, inefficient, and error-prone process. For example, in order to test whether the LTR implementation of an encoder or decoder is correct under arbitrary network conditions or models, a human tester may have to test in a real-world environment in which two applications (e.g., two computing devices running communication applications incorporating the video encoder and/or decoder) are communicating via a network channel that introduces errors in the video data. The human tester can then monitor results of the communication to see if any video corruption is occurring that should have been resolved if LTR is being implemented correctly according to the video coding standard and error recovery scenario.

In the techniques and solutions described herein, encoders and/or decoders can be tested in an automated manner, and without manual intervention, to determine whether they correctly implement LTR according to a particular video coding standard. In other words, technologies are provided for verifying LTR conformance of encoders and/or decoders. For example, encoders and/or decoders can be tested under various conditions (e.g., various network conditions that are simulated according to lossy channel models) and with a variety of types of video content. Many different scenarios can be tested by varying LTR usage patterns used for encoding and by varying lossy channel models used for modifying the encoded video sequence. In addition, the testing scenarios (e.g., including specific LTR usage patterns and lossy channel models) can be tailored to test specific LTR usage situations and rules (e.g., to test whether encoders and/or decoders correctly implement various requirements for LTR usage during encoding and/or decoding).

Furthermore, encoders and/or decoders can be tested independently (e.g., as stand-alone components) of how the encoders and/or decoders will ultimately be used. For example, the encoders and/or decoders can be tested without having to setup an actual communication connection and without having to integrate the encoders and/or decoders into other applications (e.g., video conferencing applications). As another example, the encoders and/or decoders can be tested separately, and in isolation, from their ultimate application (e.g., in a video conferencing application, as an operating system component, as a video editing application, etc.) and even before the ultimate application has been developed.

### Long-Term Reference during Encoding and Decoding

A number of video coding standards use the concept of long-term reference (LTR) in order to improve error recovery and concealment. For example, designating particular pictures for use as LTR pictures can improve error recovery and concealment during communication over channels which may experience data loss and/or corruption.

For example, during encoding an encoder can designate pictures as LTR pictures. If data corruption or data loss occurs (e.g., during transmission of a bitstream), a decoder can use the LTR pictures for error recovery and concealment.

### Long-Term Reference Usage Patterns

In the technologies described herein, LTR usage patterns are used during verification of LTR usage. An LTR usage pattern defines how pictures (e.g., video frames or fields) are assigned as LTR pictures during the encoding process. LTR usage patterns can be randomly generated (e.g., according to a network channel model). For example, an LTR usage pattern can be generated with repeating assignment of LTR pictures at random intervals (e.g., an LTR refresh periodic interval of a random number of seconds). LTR usage patterns can be generated according to a pre-determined pattern. For example, LTR pictures can be refreshed on a periodic basis (e.g., an LTR refresh periodic interval of a number of seconds defined by the LTR usage pattern). As one example, an LTR usage pattern can define that the first and second pictures of the encoded video content are set to LTR pictures, and that the LTR pictures are refreshed every 10 seconds. As another example, an LTR usage pattern can define that the first and second pictures of the encoded video content are set to LTR pictures, and that the LTR pictures are refreshed every 30 seconds.

A variety of different LTR usage patterns can be used to verify different aspects of LTR usage during encoding and/or decoding. For example, different LTR usage patterns can be created to test different error recovery and concealment scenarios in order to verify that the encoder and/or decoder is implementing the video coding standard and/or LTR usage rules correctly.

In some implementations, an LTR usage pattern is provided to a video encoder via an application programming interface (API). For example, a particular LTR usage pattern can be provided to the video decoder via the API and used to encode a particular video sequence.

### Lossy Channel Models

In the technologies described herein, lossy channel models are used during verification of LTR usage. A lossy channel model defines how video content is altered in order to simulate data corruption and/or data loss that happens over communication channels. For example, a lossy channel model can be used to simulate data corruption or loss that happens during transmission of encoded video content over a communication network (e.g., a wired or wireless network). A lossy channel model can be associated with a particular rule, or rules) for handling LTR pictures (e.g., according to a particular video coding standard) and can be used to verify that the rules are being handled correctly by the encoder and/or decoder.

In some implementations, a lossy channel model defines how pictures are dropped. For example, the lossy channel model can define a pattern of picture loss (e.g., the number of pictures to be dropped, the frequency that pictures will be dropped, etc.). The model can define how pictures will be dropped in relation to the location of LTR pictures and/or the location of other types of pictures in encoded video content. For example, the model can specify that a certain number of pictures are to be dropped immediately preceding a sequence of one or more LTR pictures.

In some implementations, a lossy channel model defines corruption that is introduced in the video data (e.g., corruption of picture data and/or other video bitstream data). For example, the lossy channel model can define a pattern of corruption (e.g., the number of pictures to corrupt, which video data to corrupt, etc.). The model can define how pictures will be corrupted in relation to the location of LTR pictures and/or the location of other types of pictures in encoded video content. For example, the model can specify that a certain number of pictures are to be corrupted immediately preceding a sequence of one or more LTR pictures. In some implementations, the lossy channel model defines a combination of data corruption and loss.

In some implementations, a lossy channel model is applied to an encoded video sequence that is produced by a video encoder. For example, the output of the video encoder can be modified according to the lossy channel model and the resulting modified encoded video sequence can be used (e.g., used immediately or saved for use later) for decoding. A lossy channel model can also be applied to an encoded video sequence that has previously been saved. A lossy channel model can also be applied as part of an encoding procedure (e.g., as a post-processing operation performed by a video encoder).

A lossy channel model can define data corruption and/or loss using a random uniform model, a Gaussian model, or another type of model. For example, a uniform random model can be used to introduce random corruption according to a uniform pattern.

In some implementations, a lossy channel model is defined by various parameters. The parameters can include parameters defining dropped packets or dropped pictures, parameters defining simulated network speed and/or bandwidth (e.g., for introducing latency variations), parameters defining error rate, and/or other types of parameters used to simulate variations that can occur in a communication channel.

### Verifying LTR Usage

In the technologies described herein, video encoders and decoders encode and decode video content according to a video coding standard (e.g., H.264, HEVC, or another video coding standard). In some cases, the video encoders and/or decoders may not correctly deal with LTR pictures according to the video coding standard and/or rules for LTR usage. Verifying LTR usage can be accomplished by separately processing two instances of the same video sequence (e.g., in two encoding and decoding passes). A first instance is encoded by a video encoder according to an LTR usage pattern and then decoded by a video decoder to create to create decoded video content for the first instance. A second instance is encoded by the video encoder (the same video encoder as used to encode the first instance) according to the LTR usage pattern (the same LTR usage pattern as used when encoding the first instance) and modified according to a lossy channel model, and then decoded by the video decoder (the same video encoder as used to encode the first instance) to create to create decoded video content for the second instance. The decoded video content for the first and second instances are then compared to determine if LTR usage has been handled correctly by the video encoder and/or the video decoder. In some implementations, LTR usage has been handled correctly when the first and second instance are bit-exact (match bit-exactly) beginning from an LTR recovery point location (e.g., from the point the LTR picture is used for error recovery). The term “perfect recovery” is used to refer to the situation where the first and second instance are bit-exact beginning from the LTR recovery point location.

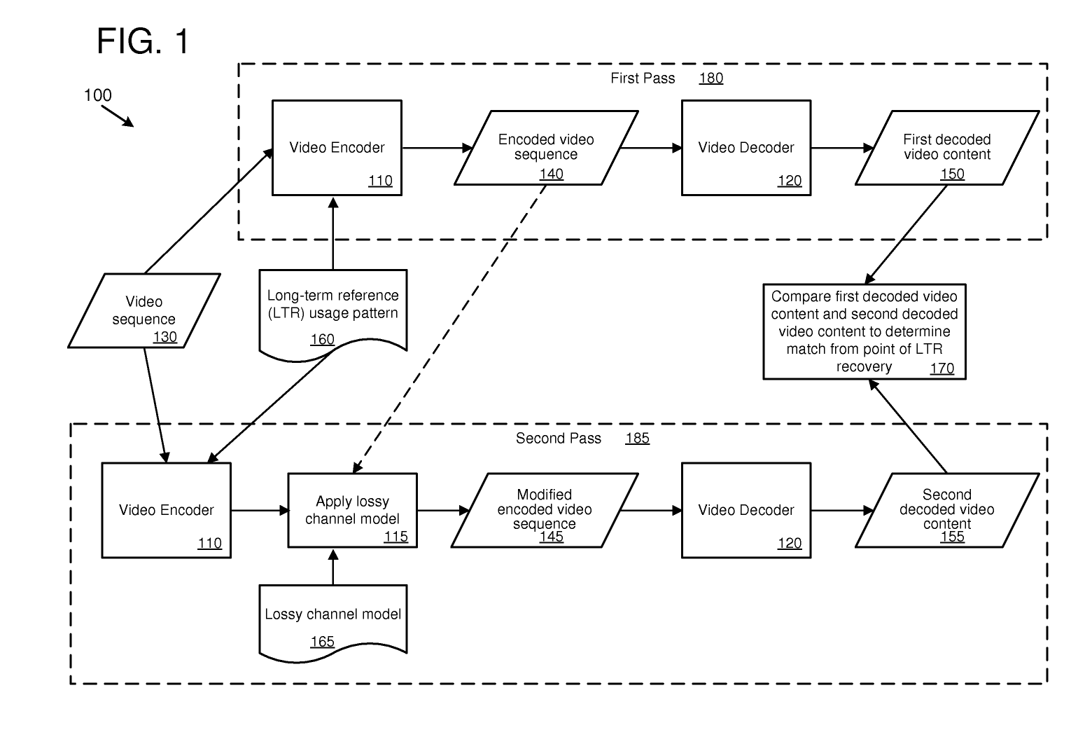

FIG. 1 is an example block diagram 100 depicting a process for verifying LTR usage during encoding and/or decoding of video content. As depicted in the example block diagram 100, a video sequence 130 is used in verifying LTR usage. The video sequence 130 can be any type of video content in an unencoded state (e.g., recorded video content, generated video content, or video content from another source). For example, the video sequence 130 can be a video sequence created or saved for testing purposes.

In the implementation depicted in the example block diagram 100, verifying LTR usage involves encoding and decoding the video sequence 130 in two different ways. In a first pass 180 procedure, the video sequence 130 is encoded with a video encoder 110. The video encoder 110 encodes the video sequence 130 according to a video coding standard (e.g., H.264, HEVC, or another video coding standard). The video encoder 110 can be implemented in software and/or hardware. The video encoder 110 may be a particular version of a video encoder from a particular source (e.g., a software H.264 video encoder of a particular version, such as version 1.0, developed by a particular software company).

The video encoder 110 encodes the video sequence 130 using an LTR usage pattern 160. The LTR usage pattern defines how pictures are assigned as LTR pictures during the encoding process. The output of the video encoder 110 is an encoded video sequence 140. The encoded video sequence 140 is then decoded by a video decoder 120. The video decoder 120 can be implemented in software and/or hardware. The video decoder 120 may be a particular version of a video decoder from a particular source (e.g., a software H.264 video decoder of a particular version, such as version 1.0, developed by a particular software company). The video encoder 110 and video decoder 120 operate according to the same video coding standard (e.g., they both encode or decode H.264 video content or they both encode or decode HEVC video content), but they may be different versions provided by different sources (e.g., provided by different hardware or software companies). The output of the video decoder 120 is first decoded video content 150.

In a second pass 185 procedure, the video sequence 130 is encoded with the video encoder 110 (the same video encoder 110 used to encode the same video sequence 130 in the first pass 180 procedure). The video encoder 110 encodes the video sequence 130 using the LTR usage pattern 160 (the same LTR usage pattern 160 used for encoding during the first pass 180 procedure).

In the second pass 185 procedure, a lossy channel model 165 is applied to the encoded video content produced by the video encoder 110, as depicted at 115. In some implementations, a separate component (e.g., a hardware and/or software component) performs the operations depicted at 115 in order to apply the lossy channel model 165. In some implementations, the video encoder 110 applies the lossy channel model 165 (e.g., as part of a post-processing operation).

Application of the lossy channel model 165 to the encoded video sequence produces the modified encoded video sequence 145. The modified encoded video sequence 145 is the same as the encoded video sequence 140 except for the modifications introduced by application of the lossy channel model 165. For example, pictures can be dropped and/or video data can be corrupted in the modified encoded video sequence 145.

In some implementations, instead of encoding the video sequence 130 by the video encoder 110 in the second pass 185 procedure, a copy of the encoded video sequence 140 is used, which is depicted by the dashed line from the encoded video sequence 140 to the application of the lossy channel model depicted at 115. In this case, a copy of the encoded video sequence 140 is used to apply the lossy channel model 165, as depicted at 115, and to create the modified encoded video sequence 145.

The modified encoded video sequence 145 is then decoded by the video decoder 120 (the same video decoder 120 used in the first pass 180 procedure). The output of the video decoder 120 is second decoded video content 155.

Once the first decoded video content 150 and the second decoded video content 155 have been created, they can be compared. As depicted at 170, the first and second decoded video content are compared to determine whether they match beginning from an LTR recovery point location. In some implementations, the first and second decoded video content match if they are bit-exact from the LTR recovery point for a particular range (e.g., for a number of pictures following the LTR recovery point). An indication of whether the first and second decoded video content match can be output. For example, information can be output (e.g., saved to a log file, displayed on a screen, emailed to a tester, or output in another way) stating that the match was successful (e.g., indicating a bit-exact match) or that the match was unsuccessful (e.g., indicating that the first and second decoded video content do not match beginning from the LTR recovery point). Other information can be output as well, such as details of an unsuccessful match (e.g., an indication of which pictures do not match).

In some implementations, comparing the first decoded video content 150 and the second decoded video content 155, as depicted at 170, is performed by comparing sample values (e.g., luma (Y) and chroma (U, V) sample values) for corresponding pictures between the first decoded video content 150 and the second decoded video content 155 beginning from a picture at the LTR recovery point and continuing for a number of subsequent pictures (e.g., covering an LTR recovery range).

In some implementations, the first pass 180 procedure and the second pass 185 procedure are performed as part of a single testing solution (e.g., performed by a single entity in order to test LTR conformance of a video encoder and video decoder). In some implementations, different operations can be performed at different times and/or by different entities. For example, the encoded video sequence 140 and modified encoded video sequence 145 can be created and saved for use during later testing (e.g., at a different location and/or by a different party) by decoding and comparing the results.

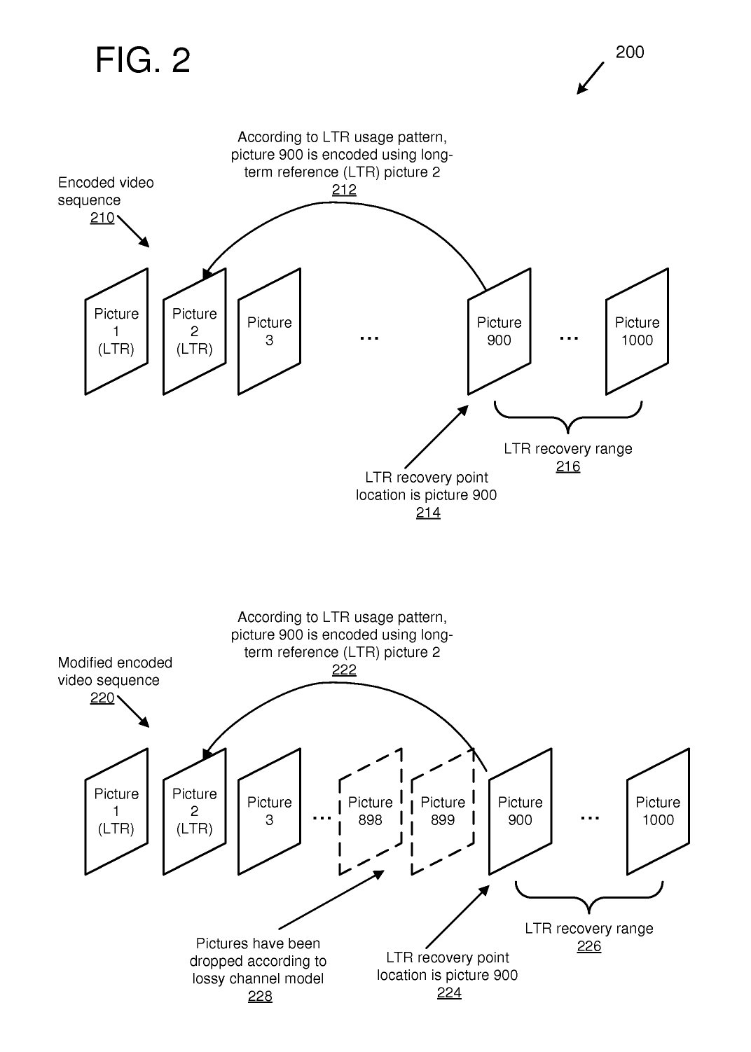

FIG. 2 is an example diagram 200 depicting modification of encoded video sequences used for verifying LTR usage. In the example diagram 200, an encoded video sequence 210 is depicted. The encoded video sequence 210 represents a video sequence (e.g., video sequence 130) that has been encoded with a video encoder (e.g., video encoder 110) according to a LTR usage pattern (e.g., LTR usage pattern 160).

The encoded video sequence 210 is a sequence of 1,000 pictures in which picture 1 and picture 2 have been designated as LTR pictures, and in which picture 900 is encoded using LTR picture 2, as depicted at 212. For example, in order to create the encoded video sequence 210, a video encoder can encode a video sequence according to an LTR usage pattern that specifies the first two pictures are assigned as LTR pictures and that specifies picture 900 will use picture 2 as a reference picture during encoding.

As depicted at 214, when the encoded video sequence 210 is decoded with a video decoder (e.g., video decoder 120), picture 900 will be the LTR recovery point location, and the range from picture 900 to picture 1,000 will be the LTR recovery range, as indicated at 216.

In the example diagram 200, a modified encoded video sequence 220 is depicted. The modified encoded video sequence 220 represents a video sequence (e.g., video sequence 130) that has been encoded with a video encoder (e.g., video encoder 110) according to an LTR usage pattern (e.g., LTR usage pattern 160) and modified according to a lossy channel model (e.g., lossy channel model 165). The modified encoded video sequence 220 contains the same encoded video content as the encoded video sequence 210 except for the modifications made according to the lossy channel model.

The modified encoded video sequence 220 is a sequence of 1,000 pictures in which picture 1 and picture 2 have been designated as LTR pictures, and in which picture 900 is encoded using LTR picture 2, as depicted at 222. Where the modified encoded video sequence 220 differs from the encoded video sequence 210 is that a number of pictures have been dropped (are not present) in the modified encoded video sequence 220. Specifically, in this example pictures 898 and 899 have been dropped, as indicated at 228.

As depicted at 224, when the modified encoded video sequence 220 is decoded with a video decoder (e.g., video decoder 120), picture 900 will be the LTR recovery point location, and the range from picture 900 to picture 1,000 will be the LTR recovery range, as indicated at 226.

In order to verify LTR usage, the encoded video sequence 210 can be decoded to create first decoded video content and the modified encoded video sequence 220 can be decoded to create second decoded video content. The first and second decoded video content can then be compared beginning from the LTR recovery point location (corresponding locations 214 and 224) over the LTR recovery range (corresponding ranges 216 and 226). In some implementations, the comparison is a match when the decoded video content is bit-exact beginning from the LTR recovery point location over the LTR recovery range.

In some implementations, comparison of decoded video content is performed by comparing sample values. In some implementations, comparison is performed by computing checksums (e.g., comparing checksums calculated from sample values using a checksum algorithm such as MD5 or cyclic redundancy checks (CRCs)).

The technologies described herein can be used to identify encoder errors with respect to LTR usage. For example, an encoded video sequence and a modified encoded video sequence can be decoded using a video decoder that is known to implement LTR correctly. If any differences are found during comparison, then an error with the video encoder can be identified and investigated. One example of an encoder error can be explained with reference to the example diagram 200. If the encoder does not correctly use LTR picture 2 when encoding picture 900 in the encoded video sequence 210 and the modified encoded video sequence 220 (e.g., because the encoded did not correctly follow the LTR usage pattern), and instead uses picture 899 as a reference picture, then the decoded video content will not match because picture 899 has been dropped from the modified encoded video sequence 220.

The technologies described herein can be used to identify decoder errors with respect to LTR usage. For example, the decoder may not correctly use an LTR picture for decoding beginning from an LTR recovery point and thus produce decoded video content that is different when compared. With reference to the example diagram 200, this situation can be illustrated. If the video decoder does not use LTR picture 2 when decoding picture 900, and instead uses picture 899, then the first decoded video content from the encoded video sequence 210 will decode pictures 900 to 1,000 using reference picture 899 (which is present in the encoded video sequence 210). The second decoded video content from the modified encoded video sequence 220 will also decode pictures 900 to 1,000 using reference picture 899. However, in the modified encoded video sequence 220, picture 899 is not present (it has been dropped). Therefore, the second decoded video content for pictures 900 to 1,000 (the LTR recovery range 226) will be different (e.g., contain artifacts, blank pictures, etc.), and when the first and second decoded video content are compared they will not be bit-exact beginning from the LTR recovery point location (corresponding locations 214 and 224).

### Methods for Verifying LTR Usage

In any of the examples herein, methods can be provided for verifying LTR picture usage by video encoders and/or video decoders.

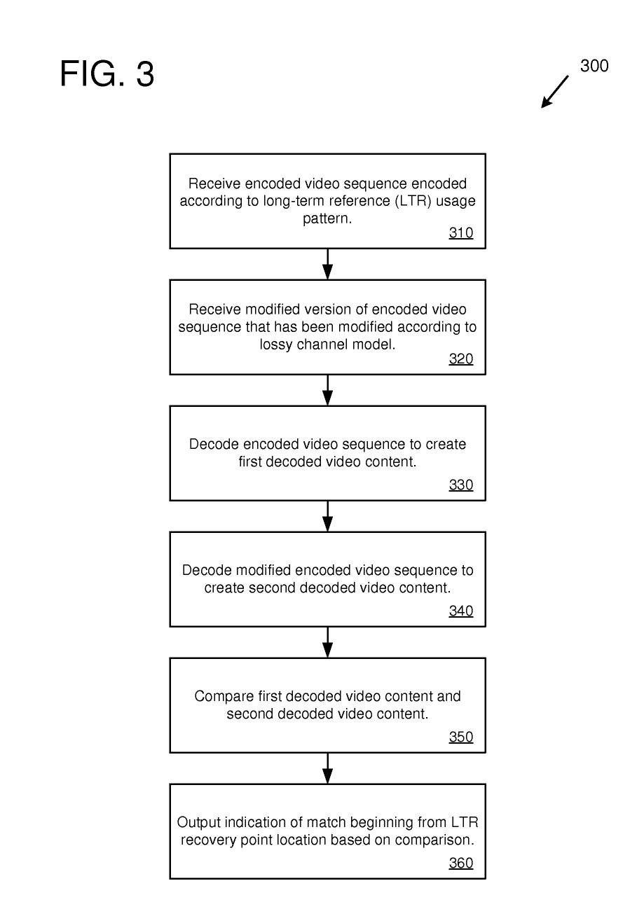

FIG. 3 is a flowchart of an example method 300 for verifying long term reference picture usage. At 310, an encoded video sequence is received. The encoded video sequence has been encoded according to an LTR usage pattern.

At 320, a modified version of the encoded video sequence is received. The modified version of the encoded video sequence has also been encoded according to the LTR usage pattern and has also been modified according to a lossy channel model. For example, the modified version of the encoded video sequence can be a copy of the encoded video sequence that is then modified according to the lossy channel model or the modified version of the encoded video sequence can be modified during the encoding process from the same video sequence that was used to encode the encoded video sequence received at 310.

At 330, the encoded video sequence (received at 310) is decoded to create first decoded video content. At 340, the modified encoded video sequence (received at 320) is decoded to create second decoded video content. The encoded video sequence and the modified encoded video sequence are decoded using the same video decoder.

At 350, the first decoded video content and the second decoded video content are compared. The comparison can be performed beginning from an LTR recovery point location (e.g., from an LTR recovery picture at the same picture location on both the first and second decoded video content).

At 360, an indication of whether the first decoded video content and the second decoded video content match beginning from the LTR recovery point location is output. For example, if there is a bit-exact match beginning from the LTR recovery point location over an LTR recovery range, then the indication can be a verification that LTR usage has been handled correctly. Otherwise, the indication can be that the LTR usage has not been handled correctly.

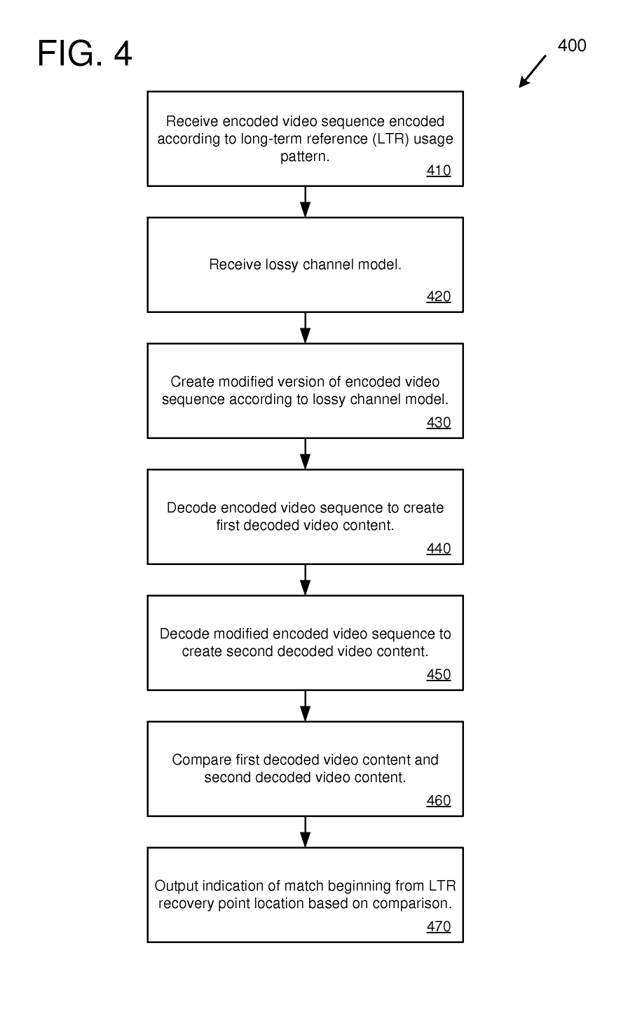

FIG. 4 is a flowchart of an example method 400 for verifying long term reference picture usage. At 410, an encoded video sequence is received. The encoded video sequence has been encoded according to an LTR usage pattern

At 420, a lossy channel model is received. The lossy channel model models video data loss (e.g., dropped pictures and/or corrupt video content) in a communication channel.

At 430, a modified version of the encoded video sequence is created according to the lossy channel model. For example, a copy of the encoded video sequence (received at 410) can be modified according to the lossy channel model or the modified version of the encoded video sequence can be modified during the encoding process from the same video sequence that was used to encode the encoded video sequence received at 410.

At 440, the encoded video sequence (received at 410) is decoded to create first decoded video content. At 450, the modified encoded video sequence (created at 430) is decoded to create second decoded video content. The encoded video sequence and the modified encoded video sequence are decoded using the same video decoder.

At 460, the first decoded video content and the second decoded video content are compared. The comparison can be performed beginning from an LTR recovery point location (e.g., from an LTR recovery picture at the same picture location on both the first and second decoded video content).

At 470, an indication of whether the first decoded video content and the second decoded video content match beginning from the LTR recovery point location is output. For example, if there is a bit-exact match beginning from the LTR recovery point location over an LTR recovery range, then the indication can be a verification that LTR usage has been handled correctly. Otherwise, the indication can be that the LTR usage has not been handled correctly.

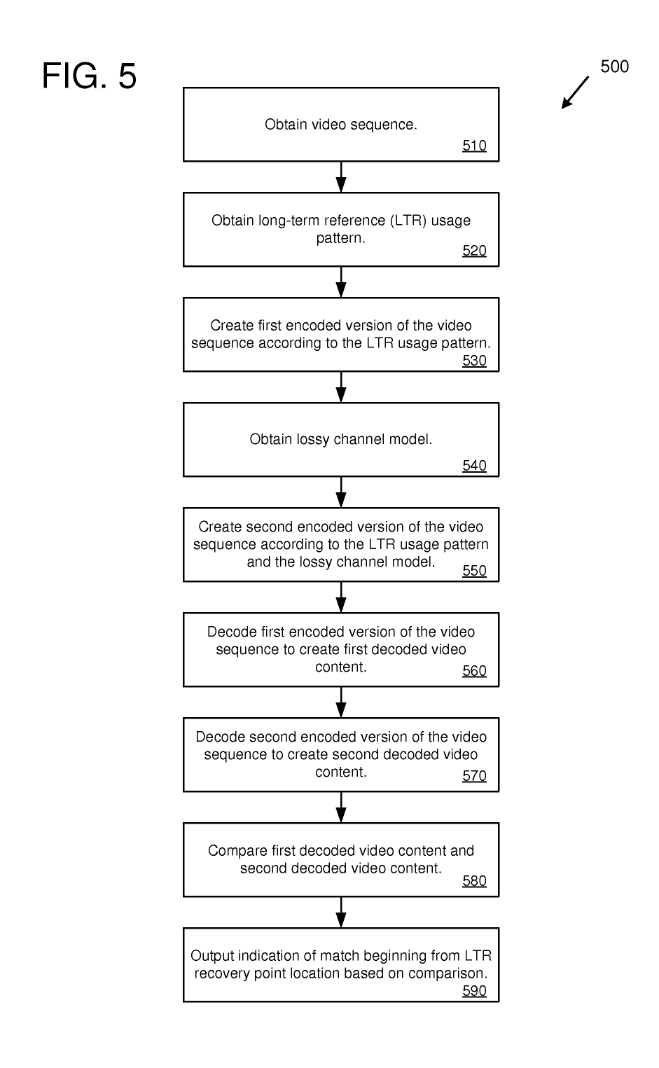

FIG. 5 is a flowchart of an example method 500 for verifying long term reference picture usage. At 510, a video sequence is obtained. The video sequence can be an unencoded video sequence (e.g., captured from a video recording device, computer-generated raw video content, decoded video content, or unencoded video from another source).

At 520, an LTR usage pattern is obtained. The LTR usage pattern defines a pattern of LTR usage during encoding of the video sequence. At 530, a first encoded version of the video sequence (obtained at 510) is created, using a video encoder, according to the LTR usage pattern (obtained at 520).

At 540 a lossy channel model is obtained. The lossy channel model models video data loss in a communication channel. At 550, a second encoded version of the video sequence (obtained at 510) is created, by the video encoder (the same video encoder used to create the first encoded version at 530), according to the LTR usage pattern (obtained at 520) and the lossy channel model (obtained at 540).

At 560, the first encoded version of the video sequence is decoded to create first decoded video content. At 570, the second encoded version of the video sequence is decoded to create second decoded video content.

At 580, the first decoded video content and the second decoded video content are compared. The comparison can be performed beginning from an LTR recovery point location (e.g., from an LTR recovery picture at the same picture location in both the first and second decoded video content).

At 590, an indication of whether the first decoded video content and the second decoded video content match beginning from the LTR recovery point location is output. For example, if there is a bit-exact match beginning from the LTR recovery point location over an LTR recovery range, then the indication can be a verification that LTR usage has been handled correctly. Otherwise, the indication can be that the LTR usage has not been handled correctly.

### Alternative Embodiments

Various combinations of the embodiments described herein can be implemented. For example components described in one embodiment can be included in other embodiments and vice versa. The following paragraphs are non-limiting examples of such combinations.

A. A method, implemented by a computing device, for verifying long term reference picture usage, the method comprising:

receiving an encoded video sequence that has been encoded according to a long-term reference (LTR) usage pattern;

receiving a modified version of the encoded video sequence, encoded according to the LTR usage pattern, that has been modified according to a lossy channel model that models video data loss in a communication channel;

decoding, by a video decoder, the encoded video sequence to create first decoded video content;

decoding, by the video decoder, the modified version of the encoded video sequence to create second decoded video content;

comparing the first decoded video content and the second decoded video content; and based on the comparing, outputting an indication of whether the first decoded video content and the second decoded video content match beginning from an LTR recovery point location.

B. The method of paragraph A wherein the LTR usage pattern defines a pattern of LTR usage during encoding, and wherein the LTR usage pattern comprises an LTR refresh periodic interval.

C. The method of any of paragraphs A through B wherein the lossy channel model defines, at least in part, how pictures are dropped in the modified version of the encoded video sequence.

D. The method of any of paragraphs A through C wherein the lossy channel model defines, at least in part, how corruption is introduced in the modified version of the encoded video sequence.

E. The method of any of paragraphs A through D wherein comparing the first decoded video content and the second decoded video content includes comparing sample values for corresponding pictures between the first decoded video content and the second decoded video content beginning from a picture at the LTR recovery point location and continuing for a number of subsequent pictures.

F. The method of any of paragraphs A through E wherein the first decoded video content and the second decoded video content match beginning from the LTR recovery point location when the first decoded video content and the second decoded video content is bit-exact over a recovery range beginning from the LTR recovery point location.

G. The method of any of paragraphs A through F including:

encoding, by a video encoder, a video sequence according to the LTR usage pattern to create the encoded video sequence; and

modifying a copy of the encoded video sequence according to the lossy channel model to create the modified version of the encoded video sequence.

H. The method of any of paragraphs A through F including:

encoding, by a video encoder, a video sequence according to the LTR usage pattern to create the encoded video sequence; and

encoding, by the video encoder, the video sequence according to the LTR usage pattern to create the modified version of the encoded video sequence by modifying an output of the video encoder according to the lossy channel model.

I. The method of any of paragraphs A through H wherein the method is performed to verify LTR conformance according to a video coding standard, wherein the video coding standard is one of HEVC and H.264.

Other alternative combinations can be as follows.

A. A computing device comprising:

a processing unit; and

memory;

the computing device configured to perform video encoding and decoding operations for verifying long term reference picture usage, the operations comprising:

receiving an encoded video sequence that has been encoded according to a long-term reference (LTR) usage pattern;
receiving a lossy channel model that models video data loss in a communication channel;
creating a modified version of the encoded video sequence according to the lossy channel model;
decoding, by a video decoder, the encoded video sequence to create first decoded video content;
decoding, by the video decoder, the modified version of the encoded video sequence to create second decoded video content;
comparing the first decoded video content and the second decoded video content; and
based on the comparing, outputting an indication of whether the first decoded video content and the second decoded video content match beginning from an LTR recovery point location.

B. The computing device of paragraph A wherein the lossy channel model defines, at least in part, one or more of:

how pictures are dropped in the modified version of the encoded video sequence; and

how corruption is introduced in the modified version of the encoded video sequence.

C. The computing device of any of paragraphs A through B the operations further including encoding, by a video encoder, a video sequence according to the LTR usage pattern to create the encoded video sequence.

D. The computing device of any of paragraphs A through C wherein comparing the first decoded video content and the second decoded video content includes comparing sample values for corresponding pictures between the first decoded video content and the second decoded video content beginning from a picture at the LTR recovery point location and continuing for a number of subsequent pictures.

E. The computing device of any of paragraphs A through D wherein the first decoded video content and the second decoded video content match beginning from the LTR recovery point location when the first decoded video content and the second decoded video content is bit-exact over a recovery range beginning from the LTR recovery point location.

F. The computing device of any of paragraphs A through E wherein the operations are performed to verify LTR conformance according to a video coding standard, wherein the video coding standard is one of HEVC and H.264.

Other alternative combinations can be as follows.

A. A computer-readable storage medium storing computer-executable instructions for causing a computing device to perform operations for verifying long term reference frame usage according to a video coding standard, the operations comprising:

obtaining a video sequence comprising a plurality of pictures;

obtaining a long-term reference (LTR) usage pattern that defines a pattern of LTR usage during encoding;

creating, using a video encoder, a first encoded version of the video sequence according to the LTR usage pattern;

obtaining a lossy channel model that models video data loss in a communication channel;

creating, using the video encoder, a second encoded version of the video sequence according to the LTR usage pattern and the lossy channel model;

decoding, using a video decoder, the first encoded version of the video sequence to create first decoded video content;

decoding, using the video decoder, the second encoded version of the video sequence to create second decoded video content;

comparing the first decoded video content and the second decoded video content; and

based on the comparing, outputting an indication of whether the first decoded video content and the second decoded video content match beginning from an LTR recovery point location.

B. The computer-readable storage medium of paragraph A wherein the lossy channel model defines, at least in part, one or more of:

how pictures are dropped in the second encoded version of the video sequence; and

how corruption is introduced in the second encoded version of the video sequence.

C. The computer-readable storage medium of any of paragraphs A through B wherein comparing the first decoded video content and the second decoded video content includes comparing sample values for corresponding pictures between the first decoded video content and the second decoded video content beginning from a picture at the LTR recovery point location and continuing for a number of subsequent pictures.

D. The computer-readable storage medium of any of paragraphs A through C wherein the first decoded video content and the second decoded video content match beginning from the LTR recovery point location when the first decoded video content and the second decoded video content is bit-exact over a recovery range beginning from the LTR recovery point location.

E. The computer-readable storage medium of any of paragraphs A through D wherein the operations are performed to verify LTR conformance according to a video coding standard, wherein the video coding standard is one of HEVC and H.264.

### Computing Systems

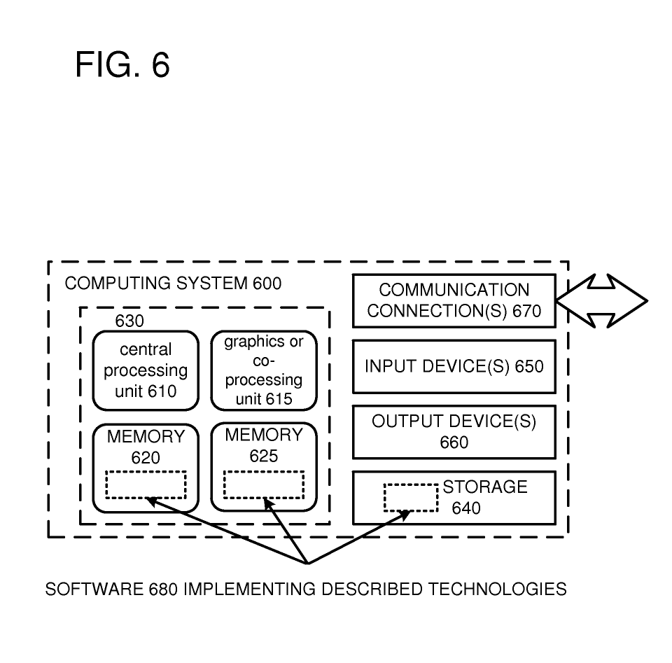

FIG. 6 depicts a generalized example of a suitable computing system 600 in which the described innovations may be implemented. The computing system 600 is not intended to suggest any limitation as to scope of use or functionality, as the innovations may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more innovations described herein, in the form of computer-executable instructions suitable for execution by the processing unit(s).

A computing system may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information and which can be accessed within the computing system 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing system 600. For video encoding, the input device(s) 650 may be a camera, video card, TV tuner card, or similar device that accepts video input in analog or digital form, or a CD-ROM or CD-RW that reads video samples into the computing system 600. The output device(s) 660 may be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (i.e., any available computing device, including smart phones or other mobile devices that include computing hardware). Computer-readable storage media are tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 6, computer-readable storage media include memory 620 and 625, and storage 640. The term computer-readable storage media does not include signals and carrier waves. In addition, the term computer-readable storage media does not include communication connections (e.g., 670).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

What is claimed is:

1. A method, implemented by a computing device, for verifying long term reference picture usage, the method comprising:
receiving an encoded video sequence that has been encoded according to a long-term reference (LTR) usage pattern;
receiving a modified version of the encoded video sequence, encoded according to the LTR usage pattern, that has been modified according to a lossy channel model that models video data loss in a communication channel;
decoding, by a video decoder, the encoded video sequence to create first decoded video content;
decoding, by the video decoder, the modified version of the encoded video sequence to create second decoded video content;
comparing the first decoded video content and the second decoded video content; and
based on the comparing, outputting an indication of whether the first decoded video content and the second decoded video content match beginning from an LTR recovery point location.

2. The method of claim 1 wherein the LTR usage pattern defines a pattern of LTR usage during encoding, and wherein the LTR usage pattern comprises an LTR refresh periodic interval.

3. The method of claim 1 wherein the lossy channel model defines, at least in part, how pictures are dropped in the modified version of the encoded video sequence.

4. The method of claim 1 wherein the lossy channel model defines, at least in part, how corruption is introduced in the modified version of the encoded video sequence.

5. The method of claim 1 wherein comparing the first decoded video content and the second decoded video content comprises:
comparing pixel sample values for corresponding pictures between the first decoded video content and the second decoded video content beginning from a picture at the LTR recovery point location and continuing for a number of subsequent pictures.

6. The method of claim 1 wherein the first decoded video content and the second decoded video content match beginning bit-exactly from the LTR recovery point location when the first decoded video content and the second decoded video content is bit-exact over a recovery range beginning from the LTR recovery point location.

7. The method of claim 1 further comprising:
encoding, by a video encoder, a video sequence according to the LTR usage pattern to create the encoded video sequence; and
modifying a copy of the encoded video sequence according to the lossy channel model to create the modified version of the encoded video sequence.

8. The method of claim 1 further comprising:
encoding, by a video encoder, a video sequence according to the LTR usage pattern to create the encoded video sequence; and
encoding, by the video encoder, the video sequence according to the LTR usage pattern to create the modified version of the encoded video sequence by modifying an output of the video encoder according to the lossy channel model.

9. The method of claim 1 wherein the method is performed to verify LTR conformance according to a video coding standard, wherein the video coding standard is one of HEVC, H.264, VP8, and VP9.

10. A computing device comprising:
a processing unit; and
memory;
the computing device configured to perform video encoding and decoding operations for verifying long term reference picture usage, the operations comprising:
receiving an encoded video sequence that has been encoded according to a long-term reference (LTR) usage pattern;
receiving a lossy channel model that models video data loss in a communication channel;
creating a modified version of the encoded video sequence according to the lossy channel model;
decoding, by a video decoder, the encoded video sequence to create first decoded video content;
decoding, by the video decoder, the modified version of the encoded video sequence to create second decoded video content;
comparing the first decoded video content and the second decoded video content; and
based on the comparing, outputting an indication of whether the first decoded video content and the second decoded video content match beginning from an LTR recovery point location.

11. The computing device of claim 10 wherein the lossy channel model defines, at least in part, one or more of:
how pictures are dropped in the modified version of the encoded video sequence; and
how corruption is introduced in the modified version of the encoded video sequence.

12. The computing device of claim 10 the operations further comprising:
encoding, by a video encoder, a video sequence according to the LTR usage pattern to create the encoded video sequence.

13. The computing device of claim 10 wherein comparing the first decoded video content and the second decoded video content comprises:
comparing pixel sample values for corresponding pictures between the first decoded video content and the second decoded video content beginning from a picture at the LTR recovery point location and continuing for a number of subsequent pictures.

14. The computing device of claim 10 wherein the first decoded video content and the second decoded video content match bit-exactly beginning from the LTR recovery point location when the first decoded video content and the second decoded video content is bit-exact over a recovery range beginning from the LTR recovery point location.

15. The computing device of claim 10 wherein the operations are performed to verify LTR conformance according to a video coding standard, wherein the video coding standard is one of HEVC, H.264, VP8, and VP9.

16. A computer-readable storage medium storing computer-executable instructions for causing a computing device to perform operations for verifying long term reference frame usage according to a video coding standard, the operations comprising:
obtaining a video sequence comprising a plurality of pictures;
obtaining a long-term reference (LTR) usage pattern that defines a pattern of LTR usage during encoding;
creating, using a video encoder, a first encoded version of the video sequence according to the LTR usage pattern;
obtaining a lossy channel model that models video data loss in a communication channel;
creating, using the video encoder, a second encoded version of the video sequence according to the LTR usage pattern and the lossy channel model;
decoding, using a video decoder, the first encoded version of the video sequence to create first decoded video content;
decoding, using the video decoder, the second encoded version of the video sequence to create second decoded video content;
comparing the first decoded video content and the second decoded video content; and
based on the comparing, outputting an indication of whether the first decoded video content and the second decoded video content match beginning from an LTR recovery point location.

17. The computer-readable storage medium of claim 16 wherein the lossy channel model defines, at least in part, one or more of:
how pictures are dropped in the second encoded version of the video sequence; and
how corruption is introduced in the second encoded version of the video sequence.

18. The computer-readable storage medium of claim 16 wherein comparing the first decoded video content and the second decoded video content comprises:
comparing sample values for corresponding pictures between the first decoded video content and the second decoded video content beginning from a picture at the LTR recovery point location and continuing for a number of subsequent pictures.

19. The computer-readable storage medium of claim 16 wherein the first decoded video content and the second decoded video content match bit-exactly beginning from the LTR recovery point location when the first decoded video content and the second decoded video content is bit-exact over a recovery range beginning from the LTR recovery point location.

20. The computer-readable storage medium of claim 16 wherein the operations are performed to verify LTR conformance according to a video coding standard, wherein the video coding standard is one of HEVC, H.264, VP8, and VP9.
